(19) United States
(12) Patent Application Publication
(10) Pub. No.: US 2010/0113106 A1
(43) Pub. Date: May 6, 2010

(54) PORTABLE IPOD CHARGER WITH ADDITIONAL FUNCTIONALITY

(75) Inventor: Ari Supran, San Clemente, CA (US)

Correspondence Address: FISH & ASSOCIATES, PC;ROBERT D. FISH, 2603 Main Street, Suite 1000, Irvine, CA, 92614-6232, US

(73) Assignee: Dana Innovations, San Clemente, CA (US)

(21) Appl. No.: 12/263,617

(22) Filed: Nov. 3, 2008

(51) Int. Cl. H04B 1/00

(52) U.S. Cl. 455/573

(57) ABSTRACT

A portable battery charger for a portable media player recharges the portable media player without needing to be plugged into a wall or other stationary power source. The portable battery charger also adds extra functionality to the portable media player by providing a command interface to control an electronic device and a wireless transmitter that operates on a frequency outside of the commonly used AM/FM bands. The portable media player preferably plugs into a cradle on the portable battery charger so that the two units seamlessly act as one unit. This combination seemingly creates a new portable media player with a longer battery life and the ability to wirelessly control devices.

### FIELD OF THE INVENTION

The field of the invention is battery chargers.

### BACKGROUND

Walkmans, portable tape players, and later portable CD-players were commonly used in the early 80's so that users could listen to music while they were on-the-go. One common problem of battery-powered devices is that after a time, the battery-powered device would run out of power. Fortunately, with the advent of nickel-cadmium, and later lithium battery technology, batteries could be recharged with ease. When a battery-powered device ran out of power, the user merely had to re-charge the device's battery using a wall socket at a home or business, or perhaps using power from a car or truck. Unfortunately, this requires the user to be at or near the external power source.

U.S. D55,892 to Oh teaches a portable battery booster. When the user is at home or in an office, the user can plug Oh's battery charger into a wall socket. Later, when the user is not near a wall socket, Oh's battery charger can be plugged into an electronic device to provide auxiliary power. Oh's battery booster, however, does not provide any additional functionality beyond providing extra power to the electronic device. Oh and all other extrinsic materials identified herein are incorporated by reference in their entirety. Where a definition or use of a term in an incorporated reference is inconsistent or contrary to the definition of that term provided herein, the definition of that term provided herein applies and the definition of that term in the reference does not apply.

U.S. Pat. No. 7,280,802 to Grady teaches a battery charger that transmits an audio stream from the portable media player over an FM band. Grady's charger, however, does not have its own battery, so that the charger can only operate when it is plugged into a car or truck, or is otherwise receiving external power. Additionally, an audio stream transmitted on an FM band frequently encounters distortion from other FM band transmissions, particularly in large cities.

U.S. D544,462 to Patel teaches a portable battery charger that transmits an audio stream from a portable media player over an FM band. The audio stream transmitted by Patel, however, still fails to overcome the problem of distortions and interference from other FM transmissions. Additionally, Patel also fails to allow the portable media player to transmit any information other than an audio stream.

Thus, there is still a need in the art for a portable charger that can both: (a) provide auxiliary power to a media player or other battery-powered device; and (b) transmit data other than a simple audio stream from the device, or otherwise enhance the functionality of the device.

### SUMMARY OF THE INVENTION

The present invention provides apparatus and methods in which a portable charger charges a battery-powered device, and also wirelessly transmits data from that device to a remote device. Preferred battery-powered devices include iPod™, iPhone™ and other portable media players, as well as Blackberry™, Palm Pilot™ and other PDAs. A “battery” is defined herein to include any electrochemical cell that stores usable amounts of electrical energy. The term “battery” excludes capacitors.

As used herein, the term “charger battery” refers to the battery (or batteries) within the portable charger. The charger battery can provide power to the battery-powered device in any suitable manner, including wirelessly or through a battery interface, and such power can be use directly to operate the battery-powered device, or indirectly by charging a battery within the battery-powered device. In an especially preferred embodiment, the device battery in the battery-powered device is only charged when its voltage drops below a specified threshold.

The charger battery can be recharged in any suitable manner, either wirelessly or through a wired interface, and either while it is contained within, or removed from, the charger. Preferably, however, the charger battery is recharged while still connected to the charger, and while the charger is receiving power through a wired connection from a wall socket.

Contemplated portable chargers have a transmitter that transmits data from the battery-powered device to a remote electronic device. A “remote electronic device” is defined herein as one that is not physically attached to the battery-powered device or to the portable charger through a wired connection, while the transmitter is being used. The transmitter can send any type of data, including for example, an audio stream received from the battery-powered device, an encoded file, or most preferably a command to the remote electronic device. It is also contemplated that the transmitter could also receive information from the remote electronic device, and relay that information to the battery-powered device. In such instances the transmitter would operate as a transceiver.

A “transmitter” is any device that transmits information using a wave form. While the transmitter could transmit information using a visible, ultraviolet or infrared frequency, preferred transmitters use radio waves because they tend to have greater range. The frequencies used in the contemplated battery chargers fall outside of the AM/FM radio waves in order to avoid any interference. As used herein, AM waves are defined as all frequencies between 520 kHz and 1710 kHz, and FM waves are defined as all frequencies between 65.8 MHz and 108 MHz. In an especially preferred embodiment, the transmitter sends and receives data at one or more radio frequencies over 1000 MHz.

The portable charger preferably has a data interface that acts as a physical bridge between the transmitter and the battery-powered device. The data interface can advantageously be positioned adjacent to the battery interface, or integrated with the battery interface to compose a single interface that provides both power and a data communication link to the battery-powered device. This single interface could be an elongated cable connection, but is preferably a cradle that is shaped and dimensioned to receive the battery-powered device. In an exemplary embodiment, the cradle comprises a recess in the portable charger that is shaped to surround a perimeter of the battery-powered device, so that the two devices appear as a single device to a casual observer. In some alternative embodiments, the battery charger could be formed as a detachable travel case for the battery-powered device. A given battery charger could have interchangeable cradles with different interfaces to accommodate different battery-powered devices.

The portable charger preferably also has a command interface that a user could use to send signals to the battery-powered device, to the remote electronic device, or to the portable charger. For example, the command interface could send a command to the portable charger to stream audio data at an increased volume or could send a command to shut down a remote electronic device. The command interface preferably manipulates hardware or software electronics within the portable charger that transmits signals between the battery-powered device and the remote electronic device. While the command interface is generally a tactile interface, for example a touch pad, a heat-sensitive pad, a spring button, and a scroll-wheel, all other suitable command interfaces are contemplated, for example an audio receiver that recognizes a user's verbal commands or a bar-code reader that responds to scanned bar codes.

In an especially preferred embodiment, the command interface is an application that is installed on the battery-powered device itself. An “application” is defined herein as any software that can be transferred to the battery-powered device and executes on an operating system installed on the battery-powered device. The application preferably displays the command interface on a visual touch-pad screen on the battery-powered device, and has customizable control buttons that can be “macroed” to perform any number of tasks.

A tracking module in the battery charger or installed on the battery-powered device could be used to detect a distance between the battery-powered device and the electronic device. Any suitable method of obtaining a distance measurement could be used, for example using RFID triangulation with repeaters or calculating a distance based upon the length of time it takes for the remote electronic device to respond to a “ping” signal from the transmitter. The combined portable charger and battery-powered device could then control the electronic device based upon this distance. For example, the combined devices could initiate a “follow-me” mode, where speakers in a room fade in and out depending on how far the portable charger is from the remote electronic device.

As defined herein, a device is “portable” when it is less than 160 ounces, and more preferably less than 80 ounces, and even more preferably less than 30 ounces.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1A is a front plan view of a portable charger in accordance with one aspect of the invention.

FIG. 1B is a side plan view of the portable charger of FIG. 1A.

FIG. 2A is a front perspective view of the portable charger of FIG. 1A in an open position.

FIG. 2B is a front perspective view of the portable charger of FIG. 2A with a portable media player placed within the cradle of the portable charger.

FIG. 2C is a front perspective view of the portable charger and portable media player of FIG. 2B, with the portable charger in a closed position.

FIG. 3A is a front plan view of the portable charger and the portable media player of FIG. 2C.

FIG. 3B is a side plan view of the portable charger and the portable media player of FIG. 3A.

FIG. 4 is a system using the portable charger and the portable media player of FIG. 3A being recharged by a dock connected to a power source.

FIG. 5 is a system using the portable charger and the portable media player of FIG. 3A controlling various remote electronic devices.

FIG. 6 is a system using the portable charger and the portable media player of FIG. 3A communicating with a computer system.

FIG. 7 is a map showing the portable charger and the portable media player of FIG. 3A controlling various speakers in a building.

### DETAILED DESCRIPTION

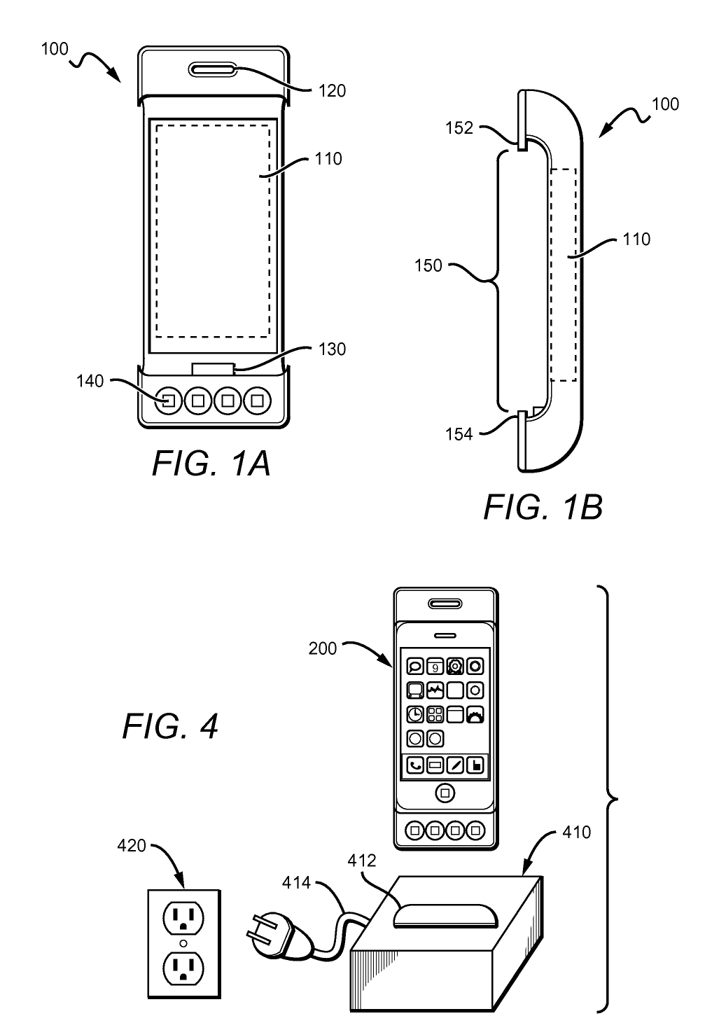

In FIGS. 1A-1B, a portable charger 100 generally includes a cradle 150, a battery 110, transmitter 120, a battery and data interface 130, and a command interface 140.

Battery 110 is generally a lithium battery within portable charger 100 that provides power to the portable charger, although battery 110 could be made from any suitable material, including for example nickel cadmium, nickel metal hydroxide, and lead acid. In this case battery 110 is an internal battery that is located within the body of portable charger 100. In an alternative embodiment, battery 110 could be removed from portable charger 100 by opening a latch (not shown) located in the back of portable charger 100. Preferably, any removable battery could be removed from the portable charger without the use of any hand tools. Those skilled in the art that there are multiple ways of including a battery in portable charger 100.

Transmitter 120 is a wireless audio transmitter that transmits and receives data using any radio frequency greater than 1000 MHz. The frequency that transmitter 120 uses can be set by the user or can be set to a default transmission frequency. It is contemplated that transmitter 120 could be set to transmit information along multiple frequencies, particularly when transmitting to multiple remote electronic devices (not shown). While transmitter 120 transmits along a radio frequency greater than 1000 MHz, transmitter 120 could transmit along any suitable frequency that is outside of the AM band and the FM band, which are defined herein as frequencies between 65.8 MHz and 108 MHz, and frequencies between 520 kHz and 1710 kHz, respectively. In alternative embodiments, transmitter 120 transmits along microwave or infrared frequencies.

Portable charger 100 is shaped to have a substantially round and rectangular perimeter, although the charger can be any suitable size or shape so long as it has a cradle that receives a portable media player. In this case, portable charger 100 has a cradle 150 that receives a portable media player (not shown) with top latch 152 and bottom latch 154. Cradle 150 is preferably detachable from the main body of the portable charger so that a user could mount multiple kinds of cradles to the portable charger, where each cradle is specifically adapted to mate with a different battery-powered device. Cradle 150 has a battery and data interface that is configured to mate with a battery and data interface on a portable media player (not shown).

Battery and data interface 130 is shown as a 30 pin connector, but could be any suitable connector that provides both power and a data communication port to a battery-powered device. In some embodiments, battery and data interface 130 is split into a separate battery interface and a data interface, particularly where the battery-powered device have separate ports for both power and data. The battery interface and the data interface in the cradle can change depending on the cradle used, so that a user could purchase a single portable charger that is able to work with a variety of different battery-powered devices, each of which has a different battery and/or data communication port.

Command interface 140 is shown as four buttons on a surface of the portable charger that operate electronics (not shown) within portable charger 100. Each button can have a different icon (not shown) that describes the separate functions of the various controls. For example, each button on the command interface could send an audio stream playing from a coupled media player to a different room, or different buttons could adjust volume or activate/deactivate certain speakers. The command interface could also send signals to the actual media player itself. In a preferred embodiment, the command interface is customizable and comprises tactile buttons on a surface of the portable charger. It is contemplated that other command interfaces may be used, for example a sliding wheel or bar that controls volume, or an audio receiver that receives verbal commands from a user that are translated into wireless signals that are sent to a remote electronic device (not shown).

While command interface 140 is shown as buttons located on portable charger 100, it is contemplated that the command interface could be an application that is installed onto the media player itself. Preferably, the application would effectuate the command interface on the media player, for example by macroing keys on the media player or displaying a remote control on a touch-screen. In an exemplary embodiment, the application is loaded on a memory (not shown) in portable charger 100, and is then installed via battery and data interface 130.

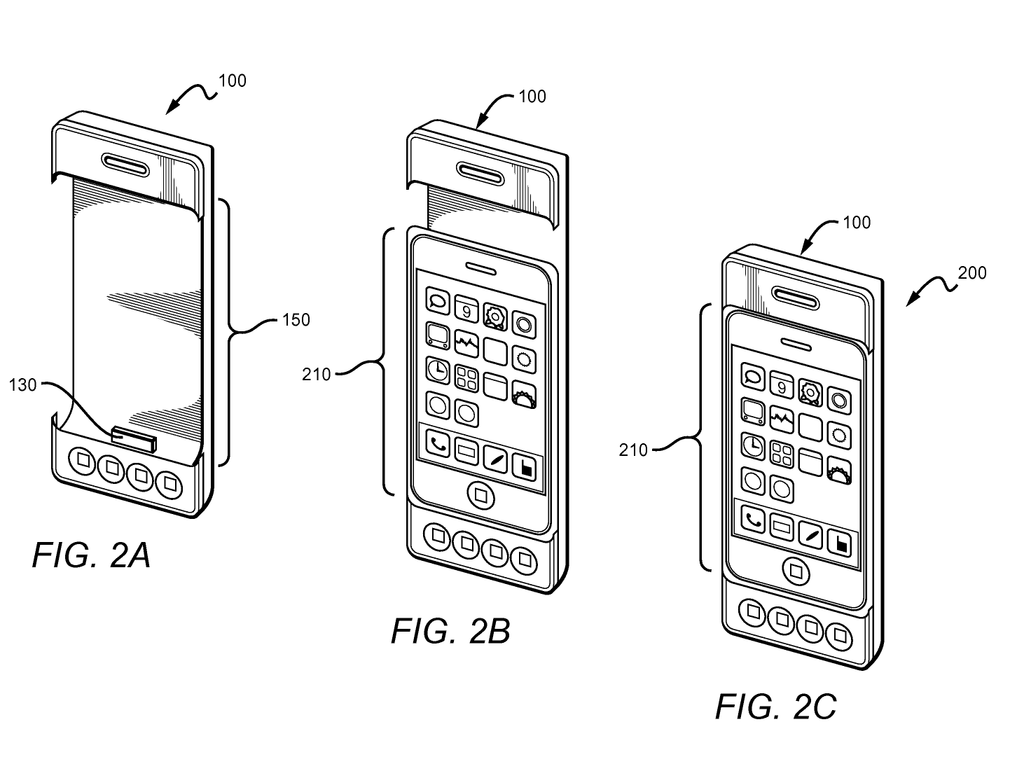

In FIGS. 2A-2C, the portable charger 100 is coupled with a portable media player 210. In FIG. 2A, the portable charger is opened so that portable media player can be coupled with cradle 150. Preferably, portable media player first mates with battery and data interface 130 before portable charger 100 is closed to form a portable media remote 200, as shown in FIG. 2C. In this case, portable media remote 200 appears to be one contiguous device when portable media player 210 mates with portable charger 100. Those skilled in the art will appreciate that the coupling has a range anywhere from a close mating to a loose footing. While cradle 150 is shown to be surrounding the portable media player along the top and bottom sides, cradle 150 could be shaped in any suitable manner to couple to portable media player 210. For example, the cradle could mate to only one side of the portable charger, or could hug and surround the entire perimeter of the portable charger.

Portable media player 210 is shown as a 5th generation Apple iPod™, although any other battery-powered device could be used, for example an Apple iTouch™, an Apple iPhone™, a Palm Pilot™, a Blackberry™, a Zune™, or a walkman. Preferably, portable media player 210 has an operating system that accepts application installations.

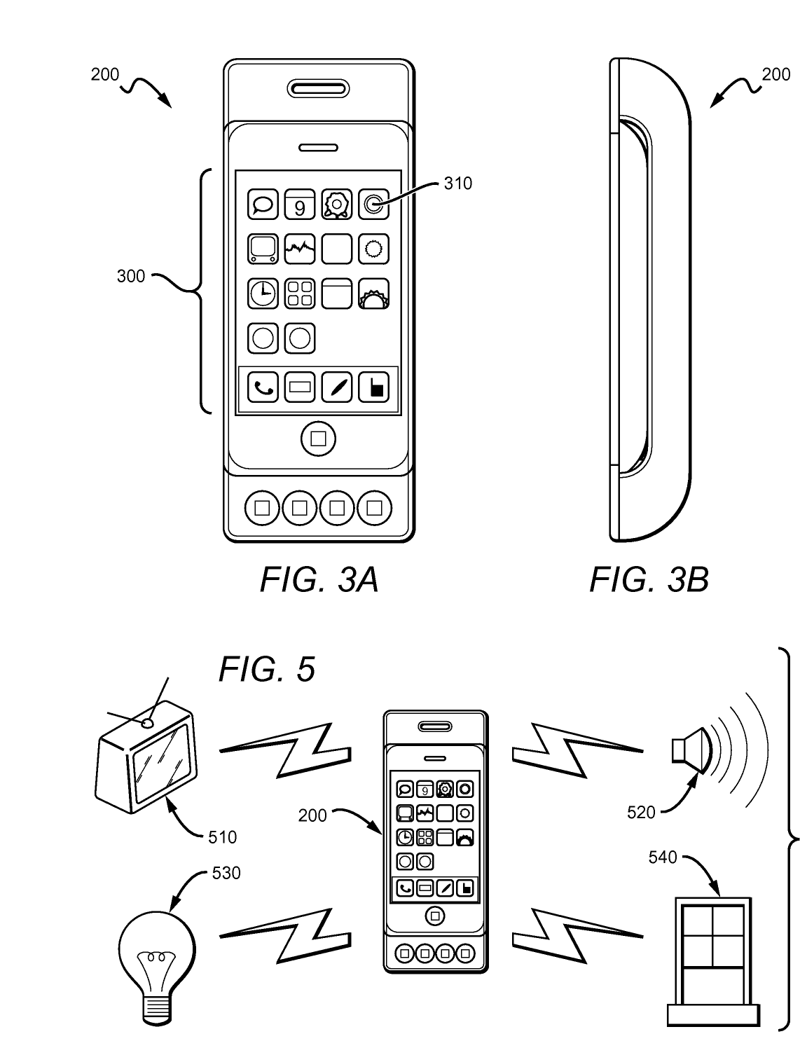

FIGS. 3A-3B show a front and side view of the portable media remote of FIG. 2C. Touch-screen 300 has a command interface with buttons 310 that could be macroed to send different commands to transmitter 120 or to a remote electronic device (not shown) via transmitter 120. As shown, portable media remote 200 has a substantially even surface in all three dimensions, so as to give a unified appearance when the portable charger is merged with the portable media player. Preferably, the portable media remote is less than 10 cm by 20 cm×3 cm, so as to be easily held in a hand.

In FIG. 4, dock 410 is placed below portable media remote 200 to recharge the portable media player. Dock 410 has a receiving cradle 412 that mates with portable charger 100 and a power cable 414 that connects to a power supply 420. Preferably, dock 410 recharges the battery (not shown) in portable charger 100 as well as the battery (not shown) in portable media player 210. Dock 410 could also connect to a computer with software that manages portable media player 210 and act as a transparent docking station to the portable media player. It is contemplated that dock 410 could load new software and firmware updates to both the portable media player and the portable charger.

In FIG. 5, portable media remote 200 transmits information to television 510, speaker 520, light source 530, and window 540. Each of television 510, speaker 520, light source 530, and window 540 is a remote electronic device that receives wireless commands from portable media remote 200 through its wireless transmitter. It is contemplated that portable media remote 200 could send commands to a television 510 to activate/deactivate, change channels, and adjust the volume, stream music to speaker 520, activate/deactivate light source 530, and open/close window 540 by sending wireless commands. It should be appreciated that many other remote electronic devices could be wirelessly controlled in this manner. The portable media remote 200 could then be transformed into a universal remote for an entire household if need be.

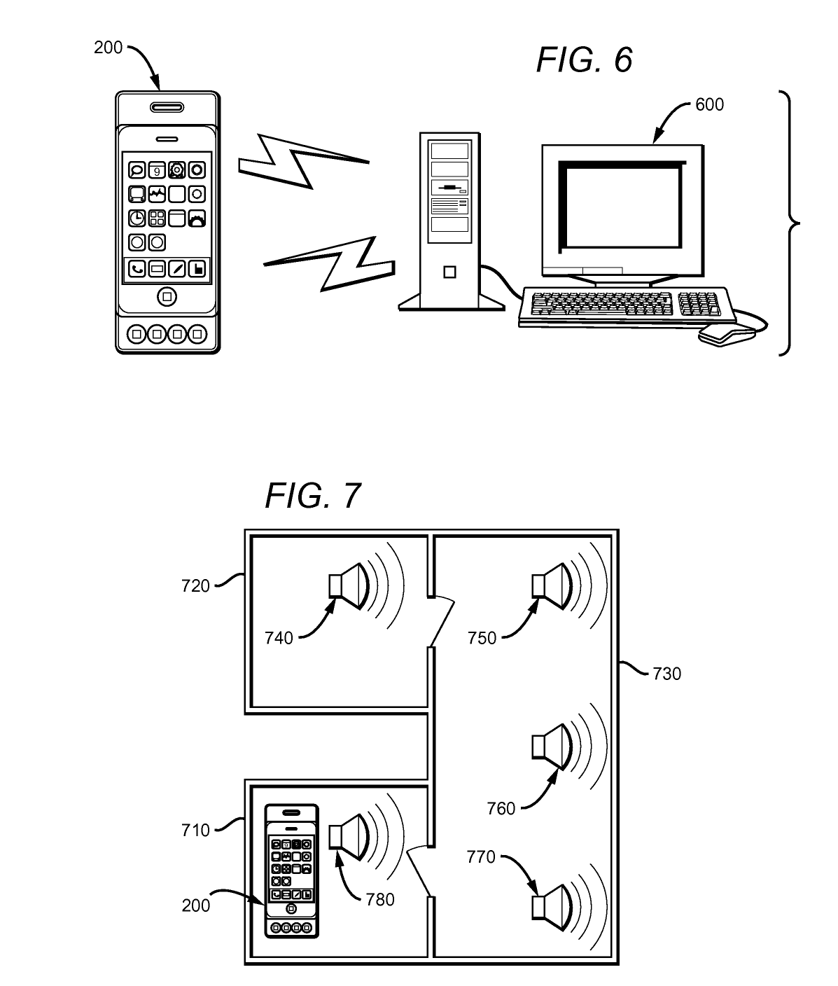

In FIG. 6, portable media remote 200 transmits information wirelessly to computer 600, and receives information wirelessly from computer 600. The portable media player sends data to the portable charger, which then forwards those signals wirelessly to the computer. In turn, the computer sends data wirelessly to the portable charger, which then forwards those signals to the portable media player. By allowing portable media remote 200 to both send and receive wireless information, the capabilities of the portable media player are greatly enhanced. For example, the portable media remote could transfer files and verify completion of transfers between the portable media remote and the computer, or could calculate its distance from computer 600 by tracking the length of time it takes for the computer to respond to a request for information. If the portable media remote has GPS capability, it could even report its location to the computer for tracking purposes. Other information could be freely transferred between the portable media remote and the computer without need of connecting the portable media remote to a docking station.

In FIG. 7, rooms 710, 720, and 730 each have one or more speakers 740, 750, 760, 770, and 780. Portable media remote 200 is configured to play music in “follow me” mode. When portable media remote 200 is in room 710, music streaming from portable media remote 200 plays on speaker 780. As portable media remote 200 is moved from room 710 to 730, portable media remote 200 detects that it is moving farther away from speaker 780 and lowers the volume of that speaker. At the same time, portable media remote 200 also detects that it is moving closer to speaker 770, and streams music to speaker 770 while gradually turning up the volume.

This “follow me” logic could be applied to many different applications, for example a user of the “follow me” media remote could program a certain show to follow him while he walks around a house. A user also could program the air conditioning to be active only in the room that the user is in. Alternatively, a user could adjust lighting and radio stations playing on different rooms. A child carrying a “follow me” media remote could send a signal to television stations that they can not display any material that is inappropriate for children under a certain age. Dynamic, automatic control of a remote electronic device is a feature that current users of portable media players just don't have.

Thus, specific embodiments and applications of providing both power and additional features to a battery-powered device have been disclosed. It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A portable charger for a battery-powered device, comprising:
a charger battery and a battery interface that cooperate to provide power to the battery-powered device;
a data interface that transmits data between the battery-powered device and the charger;
a transmitter that transmits a stream of data received from the battery-powered device to a remote electronic device, wherein the stream of data is transmitted at a frequency outside of 65.8 to 108 MHz and outside of 520 kHz-1710 kHz; and
a cradle that receives the battery-powered device.

2. The portable charger of claim 1, wherein the charger battery is removable from the portable charger.

3. The portable charger of claim 1, further comprising a detachable charger that recharges the charger battery.

4. The portable charger of claim 1, wherein the frequency is a radio frequency.

5. The portable charger of claim 1, wherein the frequency is at least 1000 MHz.

6. The portable charger of claim 1, wherein the battery interface and the data interface compose the cradle.

7. The portable charger of claim 1, wherein the battery interface and the data interface compose a single interface.

8. The portable charger of claim 1, wherein the device is a portable media player.

9. The portable charger of claim 1, wherein the battery charger comprises a detachable travel case.

10. The portable charger of claim 1, further comprising an interface that sends commands through the transmitter to a remote electronic device.

11. A method of operating an electronic device through a portable media player, comprising:
providing a cradle with a rechargeable battery;
providing power from the rechargeable battery to the portable media player through the cradle; and
providing a command interface that operates electronics within the cradle to control the electronic device, wherein the command interface is on at least one of the cradle and the portable media player.

12. The method of claim 11, further comprising a dock for the cradle that recharges the rechargeable battery.

13. The method of claim 12, further comprising loading an application onto the media player that effectuates the command interface on the media player.

14. The method of claim 12, further comprising loading the application onto the media player from the cradle.

15. The method of claim 11, wherein the command interface is customizable.

16. The method of claim 11, wherein the command interface comprises a tactile button.

17. The method of claim 11, further comprising sending signals wirelessly from the cradle to the electronic device in response to a signal received through the command interface.

18. The method of claim 11, further comprising receiving wireless signals from the electronic device to the cradle.

19. The method of claim 18, further comprising forwarding the wireless signals from the cradle to the media player.

20. The method of claim 11, further comprising detecting a distance between the media player and the electronic device.

21. The method of claim 20, further comprising controlling the electronic device based upon the distance.
